(19) United States
(12) Patent Application Publication
(10) Pub. No.: US 2014/0164385 A1
(43) Pub. Date: Jun. 12, 2014

(54) Method And System For Categorizing Users Browsing Web Content

(71) Applicant: SHARE THIS INC., Palo Alto, CA (US)

(72) Inventors: Yandong LIU, Sunnyvale, CA (US); Yan QU, Los Altos, CA (US)

(73) Assignee: SHARE THIS INC., Palo Alto, CA (US)

(21) Appl. No.: 13/709,421

(22) Filed: Dec. 10, 2012

(51) Int. Cl. G06F 17/30

(52) U.S. Cl. CPC G06F 17/30705
USPC 707/740

(57) ABSTRACT

The present invention discloses a method and a web analytics server to categorize a plurality of users browsing one or more web pages. A tracking application module is provided to receive at least one log record, the at least one log record corresponding to one or more user activities from a predefined group of user activities for the plurality of users. Further, a probability generator module is provided to generate a probability data that defines a transition from a current user activity to another user activity in the predefined group of user activities for the plurality of users, and an analytics module is configured to profile the effect of a current user activity to another user activity and to categorize the plurality of users into a plurality of categories based on the probability data.

### FIELD

The present disclosure relates, in general, to a system for categorizing users as well as its application. More specifically, the present disclosure relates to a system for categorizing users on the internet browsing web content based on the transition of a user from one user activity on the web to another, where the user activities information is derived from the user's historical web browsing pattern.

### BACKGROUND

The Internet has emerged as the most sought after information and entertainment source in recent years. At any instant, there may be millions of users involved in a variety of activities over the internet. Concomitant with the ever-increasing scope and reach of the Internet is the increasing popularity of published media on web sites and other online resources and the ability to categorize users based on choices and interests of users who access them. It is important for the commercial and non-commercial entities that rely on published media to be able to determine the scope and nature of users to influence more business. It is, therefore, desirable to know more about the target audience to realize an optimum return of the associated investments.

### SUMMARY

In an embodiment, a web analytics server for categorizing a plurality of users browsing one or more web pages is disclosed. The web analytics server includes a tracking application module configured to receive at least one log record. The at least one log record corresponds to one or more user activities from a predefined group of user activities for the plurality of users. Further, the web analytics server includes a probability generator module configured to generate a probability data that defines a transition from a current user activity to another user activity in the predefined group of user activities for the plurality of users. Finally, the web analytics server includes an analytics module configured to categorize the plurality of users into a plurality of categories based on the probability data.

In another embodiment, a method for categorizing a plurality of users browsing one or more web pages is provided. The method includes receiving at least one log record corresponding to one or more user activities from a predefined group of user activities for the plurality of users. Thereafter, the method includes determining a current user activity from the predefined group of user activities for the plurality of users based on the corresponding at least one log record, and generating a probability data that defines a transition from the current user activity to another user activity in the predefined group of user activities for the plurality of users. Finally, the method includes categorizing the plurality of users based on the probability data.

In yet another embodiment, a computer implemented method for creating a user model comprising a plurality of users browsing one or more web pages is provided. The method includes gathering at least one log record from the one or more web pages. Further, the method includes determining one or more user characteristics based at least in part on the at least one record, and determining probability data. The probability data defines a transition of the plurality of users from a current user activity to any other user activity in a predefined group of user activities. Finally, the method includes generating the user model based at least in part on the determined probability and the at least one log record.

### BRIEF DESCRIPTION OF DRAWINGS

The following detailed description of the embodiments of the disclosure will be better understood when read with reference to the appended drawings. The disclosure is illustrated by way of example, and is not limited by the accompanying figures, in which like references indicate similar elements.

FIG. 1 illustrates a system environment in which the disclosed embodiments can be implemented in accordance with an embodiment;

FIG. 2 illustrates a block diagram of a web analytics server in accordance with an embodiment;

FIG. 3 illustrates a purchase funnel diagram comprising a predefined group of user engagement levels in accordance with an embodiment;

FIG. 4 illustrates a table showing various fields included within at least one log record in accordance with an embodiment;

FIG. 5 illustrates an activity data table showing various fields generated by a user activity module in accordance with an embodiment;

FIG. 6 illustrates a probability data table generated by a probability generator module in accordance with an embodiment;

FIG. 7 illustrates a graph depicting the immediate transition of a plurality of users occurring in a single day in accordance with an embodiment;

FIG. 8 illustrates a graph depicting the non-immediate transition of a plurality of users occurring in a week in accordance with an embodiment;

FIG. 9 is a flow chart that illustrates a method of categorizing users in accordance with an embodiment;

FIG. 10 is a flow chart that illustrates a computer implemented method for creating a user model in accordance with an embodiment; and

FIG. 11 illustrates a table for computing the effect of previous user interest and the effect of an ad exposure based on a probability data.

### DETAILED DESCRIPTION

The present disclosure can be best understood when read with reference to the detailed figures and description set forth herein. Various embodiments are discussed below with reference to the figures. However, those skilled in the art will readily appreciate that the detailed description given herein with respect to these figures is just for explanatory purposes as methods and systems of the disclosure extend beyond the described embodiments. For example, those skilled in the art will appreciate that in light of the teachings presented multiple alternative and suitable approaches can be recognized depending on the needs of a particular application to implement the functionality of any detail described herein.

### Definition of Terms:

Predefined group of user activities: A predefined group of user activities (herein referred to as user activities) corresponds to various activities performed by a user while browsing through web sites on the Internet. Examples of the user activities may include, but are not limited to, viewing activity, clicking activity, sharing activity, searching activity, visiting activity, engaging with an advertisement (ad), conversion, referral and/or the like. In an embodiment, the user activities can also include non-voluntary activities, such as being exposed to an ad or being served with a survey while browsing the content.

Viewing activity: A viewing activity corresponds to a user activity in which a user views a web content, e.g. a web page, a length of video etc., published on a website.

Clicking Activity: A clicking activity corresponds to a user activity in which a user clicks on a web content. In addition, the clicking activity also refers to a user activity in which the user clicks on a web content that is shared by one or more users.

Sharing activity: A sharing activity corresponds to a user activity in which a user shares web content such as, but not limited to, a Uniform Resource Locator (URL), a video content, a video blog, a published document, and an audio file with other users of the Internet. For example, a first user may share a URL over an email, an instant messenger, or social networking sites.

Searching Activity: A searching activity corresponds to a user activity in which a user searches for web content, such as a product or a service, displayed on published web content.

Searching Clicking Activity: A searching clicking activity corresponds to a user activity in which a user clicks on the content displayed as a result of the user searching for web content, such as a product or a service, displayed on published web content.

Visiting Activity: A visiting activity corresponds to a user activity in which a user visits a web link either directly or visits a web link associated with the published web content. For example, a user may visit the Nike web link directly at www.nike.com or a user may visit the Nike web link associated with the Nike product displayed as an advertisement in the published web content.

Ad Exposure Activity: An ad exposure activity corresponds to an ad display event that is displayed to a user while the user is browsing the web, such as when viewing web pages, viewing video clips, playing online games, etc.

Ad Click Activity: An ad click activity corresponds to a click on the ad that is delivered to a user when the user is browsing the web, such as when viewing web pages, viewing video clips, playing online games, etc.

Conversion: A conversion corresponds to a user viewing the published web content on one or a plurality of web pages, clicking on it, and finally buying a product or service from the web server's store.

Log record: A log record comprises data indicative of user activities performed by a user on the Internet. Further, the log record may include a cookie, a timestamp, user activities, sharing channels, content identifiers, domain information, a browser agent, URL, a reference URL (refURL), and/or the like.

Tracking component: A tracking component is a web-based component that is part of a web page configured to generate log records. The log records facilitate tracking of a plurality of users. Examples of the tracking component include, but are not limited to, a widget, a button, a web bug, a hypertext, a web beacon, a tracking pixel, a link on each web page, a local shared object (LSO), or a HyperText Markup Language (HTML) tracking code.

Sharing Channel: A sharing channel corresponds to a website or a platform through which a sharing activity takes place. For example, www.facebook.com represents the social networking channel Facebook®. Similarly, the sharing channel can be, but is not limited to, Twitter®, LinkedIn®, Google+®, Hi5®, Orkut®, and/or the like.

Web content data: A web content data consists of data from the web pages that are designed to be presented to a user through a browser. The data includes, but is not limited to, text, image, audio, video, metadata, hyperlinks, advertisements, coupons, online auctions, and/or the like.

References to “one embodiment”, “an embodiment”, “one example”, “an example”, “for example” and so on, indicate that the embodiment(s) or example(s) so described may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment, although it may.

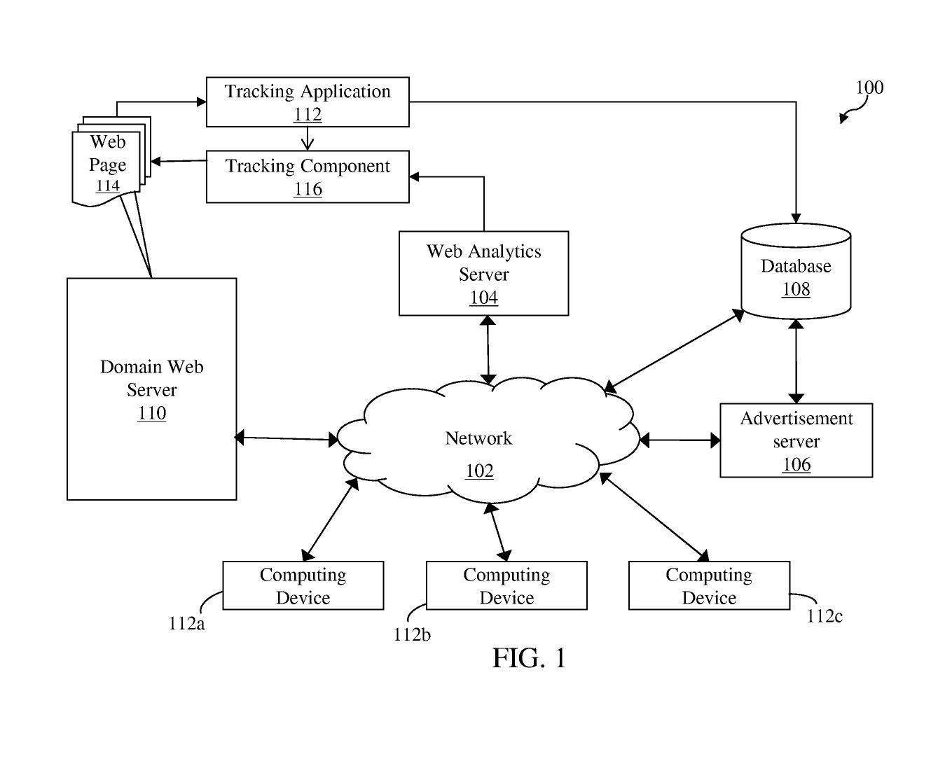

FIG. 1 illustrates a system environment 100 in which the disclosed embodiments can be implemented in accordance with an embodiment. The system environment 100 includes a network 102, a web analytics server 104, an advertisement server 106, a database 108, one or more domain web servers indicated as domain web server 110, and one or more computing devices 112a, 112b, and 112c (hereinafter referred to as computing device 112). The web analytics server 104, the advertisement server 106, the database 108, the domain web server 110 and the computing device 112 are connected via the network 102.

The network 102 corresponds to a medium through which the content and the messages flow between the various components (e.g. the web analytics server 104, the database 108, the domain web server 110, and the computing device 112) of the system environment 100. Examples of the network 102 may include, but are not limited to, a television broadcasting system, an Internet Protocol Television (IPTV) network, a Wireless Fidelity (WiFi) network, a Wide Area Network (WAN), a Local Area Network (LAN) or a Metropolitan Area Network (MAN). Various devices in the system environment 100 connect to the network 102 in accordance with various wired and wireless communication protocols such as Transmission Control Protocol and Internet Protocol (TCP/IP), User Datagram Protocol (UDP), and 2G, 3G or 4G communication protocols.

In an embodiment, the web analytics server 104 corresponds to a web analytics system having capabilities to extract and analyze data for commercial purposes. The web analytics server 104 includes various analytical tools for obtaining insights of user behaviour patterns and a path followed by users to reach conversion, for example, sales closure. Further, the web analytics server is configured for identifying a set of users for targeting them for commercial purposes, such as delivering marketing content or online product auctions. Examples of such analytical tools may include, but are not limited to, a tracking application module, a probability generator module, a categorizing module, etc. Further, the web analytics server 104 includes various analytical tools for leading users to a point of conversion. The web analytics server 104 may extract the data using various querying languages, such as Structured Query Language (SQL), 4D Query Language, Object Query Language, and Stack Based Query Language (SBQL). Examples of such analytical tools may include, but are not limited to, a tracking tool, a social behaviour analytics tool, a probability generation tool, an audience segmentation tool, a user modeling tool, a campaign analytics tool, a campaign optimization tool, a statistics package tool, a content analysis tool and a categorization tool, etc.

The advertisement server 106 corresponds to a server that serves one or more advertisements to one or more domains. For example, the advertisement server 106 may host an online shopping web site or domain that offers products of one or more categories and/or brands. The advertisement server 106 may include a predetermined data set associated with the one or more advertisement domains. In an embodiment, the predetermined data set may correspond to an advertisement campaign data and survey data. In an embodiment, the advertisement server 106 stores the predetermined data set in the database 108. The advertisement server 106 can be configured to store and publish advertisements/surveys associated with the predetermined data set across the domain web server 110. Examples of the advertisement server 106, may include, but are not limited to, an FTP server, an HTTP server, a mail server, a proxy server, and/or the like.

The database 108 corresponds to a storage device that stores data required to obtain insights of user behavior patterns and paths followed by users to reach conversion in a networked environment. The database 108 further stores a user model and log records corresponding to the user activities on the plurality of web sites. The database 108 can be implemented by using several technologies that are well known to those skilled in the art. Some examples of such technologies may include, but are not limited to, MySQL®, Microsoft SQL®, Amazon Simple Storage Service (Amazon S3), Apache Hadoop™, Apache Hive™, Apache PIG™, and/or the like. Information may be stored in the database 108 as a continuous set of data segmented to form a contiguous whole, or separated into different segments to reside in and among one or more databases, as well as partitioned for storage in one or more files to achieve efficiency in storage, accessing, and processing of data records. Further, format of data storage may be ASCII text, comma delimited ACT, EXCEL, ACCESS, TEXT, DBASE, or other database formats.

The domain web server 110 corresponds to a web server that includes data and information required to host one or more web pages (such as a web page 114). The domain web server 110 loads a tracking application 112 from the web analytics server 104 on the one or more web pages resulting in one or more tracking components (such as a tracking component 116). In an embodiment, the tracking component 116 is configured to track and store one or more user activities on the one or more web pages to form at least one log record. In an embodiment, the domain web server 110 stores the at least one log record in the database 108. Examples of the domain web server 110 may include, but are not limited to, Apache® web server, Microsoft® IIS server, Sun® Java System Web Server, and/or the like. Although only one domain web server has been shown in the figure, it may be appreciated that the disclosed embodiments can be implemented with a large number of domain web servers.

The computing device 112 may correspond to a device capable of receiving an input from a user. Examples of the computing device 112 may include, but are not limited to, laptops, televisions, tablet computers, desktops, mobile phones, gaming consoles and other such devices having capabilities of receiving the user input. Further, the computing device 112 may include a user interface that provides a user with an option to navigate through content on a web page. Although three computing devices have been shown in the figure, it may be appreciated that the disclosed embodiments can be implemented with a large number and different types of computing devices from various manufacturers. It may also be appreciated that, for a larger number of computing devices, the web analytics server 104 may be implemented as a cluster of computing devices configured to jointly perform the functions of the web analytics server 104.

In operation, a user (not shown) associated with the computing device 112 may browse through the one or more web pages hosted by the domain web server 110. The user performs one or more user activities on the one or more web pages. The domain web server 110 includes the tracking component 116 that tracks and stores such user activities in the database 108 as at least one log record. In an embodiment, the at least one log record includes a cookie, a timestamp, an activity type, a sharing channel, a content identifier, domain information, and a browser agent, and/or the like.

The web analytics server 104 extracts the at least one log record from the database 108. Thereafter, based on the at least one log record, the web analytics server 104 generates a characterization table. In an embodiment, the characterization table depicts probabilities of transitions of the plurality of users across the network 102 based on the at least one log record. In an embodiment, the web analytics server 104 receives the predetermined data set containing advertisements/surveys from the advertisement server 106. In another embodiment, the web analytics server 104 extracts the predetermined data set from the database 108. Thereafter, based on the at least one log record, the web analytics server 104 generates user event sequences for the plurality of users. In an embodiment, the user event sequences for each user include an event type, an event timestamp, as well as other necessary information associated with the event. All events are organized in the order of timestamp present on the at least one log record. Based on the user event sequences data, the web analytics server 104 further categorizes the plurality of users by computing probabilities of transitioning from one user activity to at least one another user activity.

In yet another embodiment, the web analytics server 104 receives at least one log record, the at least one log record corresponding to one or more user activities for preferably each of the plurality of users. The web analytics server 104 determines a current user activity for preferably each of the plurality of users based on time stamps corresponding to user activities for each of the plurality of users. Thereafter, the web analytics server 104 generates a probability data corresponding to a transition from the current user activity to at least one subsequent user activity for the plurality of users. Thereafter, the web analytics server 104 categorizes the plurality of users based on the probability data.

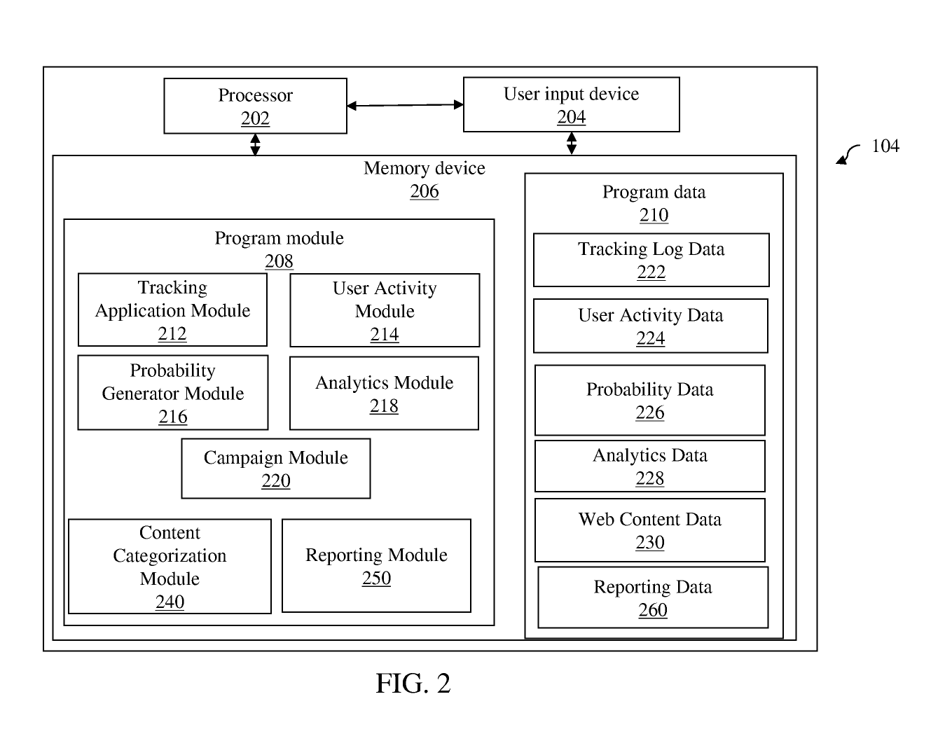

FIG. 2 illustrates a block diagram of the web analytics server 104 in accordance with an embodiment. The web analytics server 104 includes a processor 202, a user input device 204, and a memory device 206. FIG. 2 is explained in detail in conjunction with FIG. 1.

The processor 202 is coupled to the user input device 204 and the memory device 206. The processor 202 is configured to fetch a set of instructions stored in the memory device 206 and execute the set of instructions. The processor 202 can be realized through a number of processor technologies known in the art. Example of the processor 202 include, but is not limited to, X86 processor, RISC processor, ASIC processor, CSIC processor, or any other processor. The user input device 204 is configured to receive an input from the user. Examples of the user input device 204 may include, but are not limited to, a keyboard, a mouse, a joystick, a gamepad, a stylus, a touch screen, and/or the like.

The memory device 206 is configured to store data and a set of instructions or modules. Some of the commonly known memory device implementations can be, but are not limited to, a random access memory (RAM), read only memory (ROM), hard disk drive (HDD), and secure digital (SD) card. The memory device 206 is partitioned into two parts, where the two partitions include a program module 208 and a program data 210. The program module 208 includes a set of instructions that can be executed by the processor 202 to perform specific actions on the web analytics server 104. The program module 208 further includes a tracking application module 212, a user activity module 214, a probability generator module 216, an analytics module 218, a campaign module 220, a content categorization module 240, and a reporting module 250. Although various modules in the program module 208 have been shown in separate blocks, it may be appreciated that one or more of the modules may be implemented as an integrated module performing the combined functions of the constituent modules.

The program data 210 includes a tracking log data 222, a user activity data 224, a probability data 226, an analytics data 228, a web content data 230, and a reporting data 260.

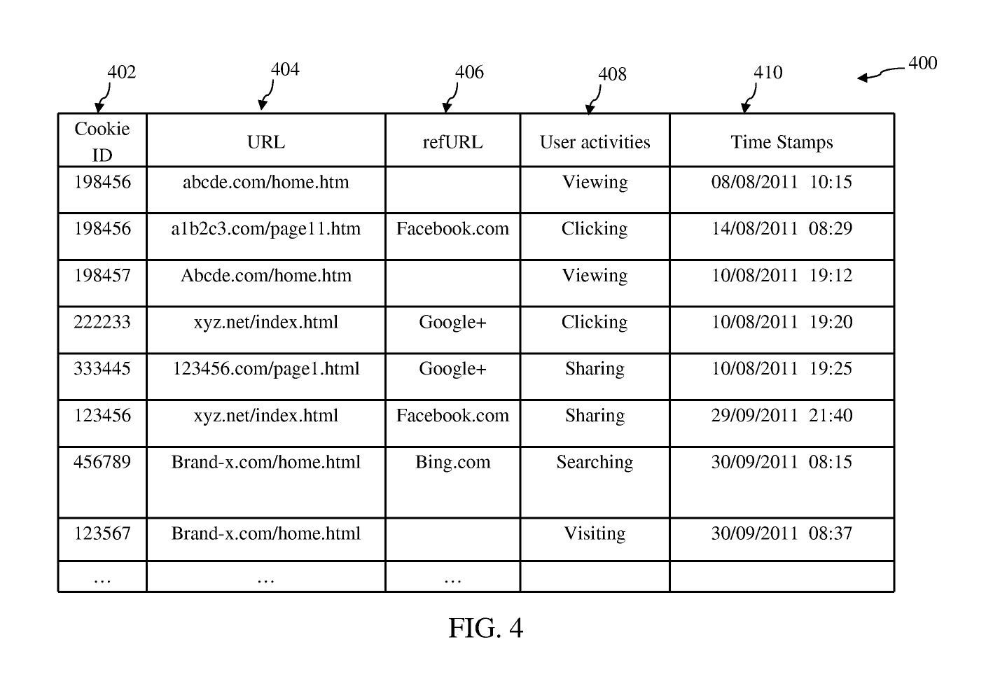

The tracking application module 212 is configured to receive at least one log record corresponding to preferably each of the plurality of users. The at least one log record includes one or more user activities from a predefined group of user activities for preferably each of the plurality of users. The tracking application module 212 receives at least one log record from the tracking component 116 and stores the at least one log record in the tracking log data 222. In an embodiment, the tracking application module 212 stores the at least one log record in the database 108. The tracking log data 222 includes a table 400 that illustrates various fields which can be included therein. The table 400 is explained in detail below with reference to FIG. 4. In another embodiment, the tracking application module 212 is configured to receive at least one log record corresponding to advertising/retargeting/impression/and/or ad clicking activities.

The content categorization module 240 is configured to categorize the content on the one or more web pages in the tracking log data 222 into pre-defined categories. Categories can be arranged at different levels representing specific levels of interests relevant for an advertiser. In an implementation, for example, the user visits a web page www.x11y22z33.com that displays content related to car sales in a particular geographical region. In an embodiment, the content is categorized as “automotive”. In another embodiment, the categorized content could further be categorized as “sales” under the category “automotive”. Further, the categories assigned to the content are stored in the tracking log data 222.

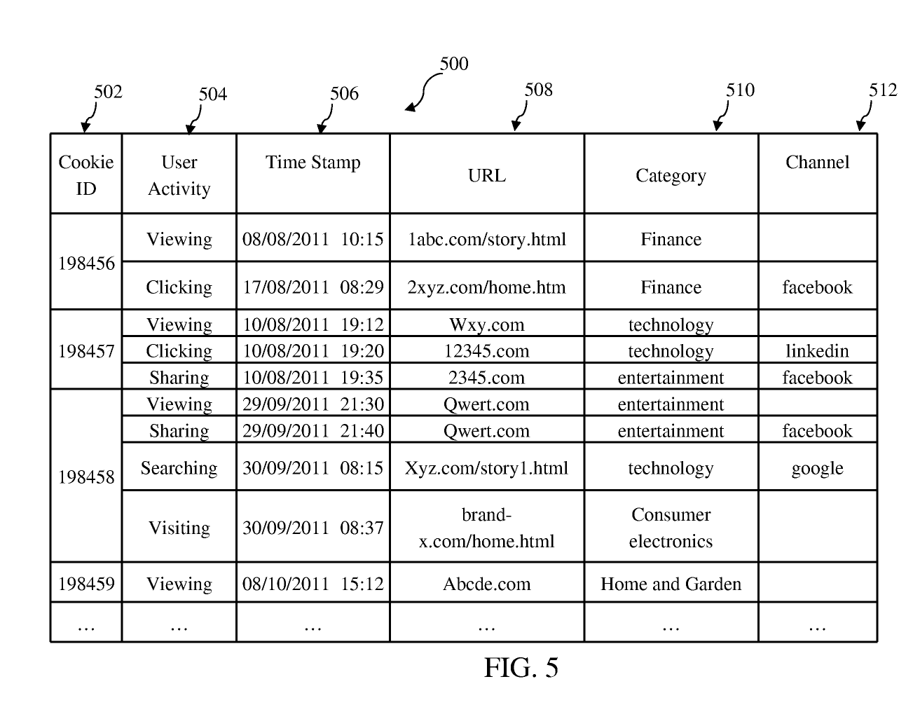

The user activity module 214 is configured to retrieve data corresponding to user activities for a plurality of users from the tracking log data 222 and store the data in the user activity data 224. In an embodiment, the user activity data 224 includes the user activities and associated time stamps corresponding to the one or more of the plurality of users. Further, the user activity module 214 is configured to identify a current activity of one or more of the plurality of users. In another embodiment, the user activity module 214 compares timestamps of user activities associated with a user of the plurality of users, and determines a current user activity of the user. In a similar way, the user activity module 214 determines the current user activity for the plurality of users. In an embodiment, the user activity module 214 determines a previous user activity for the plurality of users. The previous user activity corresponds to a user activity that has been performed prior to a transition of the user to the current user activity. The user activity module 214 may store an exemplary user activity table 500 in the user activity data 224. The exemplary user activity table 500 is explained in detail below with reference to FIG. 5.

The probability generator module 216 is configured to generate a probability data based upon contents of the user activity data 224. The probability data comprises estimated probabilities of transition from a predefined user activity to another predefined user activity for the plurality of users. In an embodiment, the probability generator module 216 estimates N-grams statistics and thereafter generates probabilities. Thereafter, the probability generator module 216 stores the probabilities in the probability data 226. The N-gram model is a probabilistic model for predicting a next event from a group of events in a sequence. N-grams can be easily scaled up and correlated with time. In multiple embodiments, the N-gram can be unigram, bigram, trigram, and/or the like. The unigram describes an occurrence of a user activity or state. Similarly, the bigram represents a sequence of two user activities or states, i.e. from a first user activity to a second user activity. N-gram can be based on consecutive user activity sequences or non-consecutive user activity sequences. For example, a user Y engages in three activities in the following sequence: first a viewing activity, then a clicking activity, and lastly a visiting activity. For this user, unigram activities include “viewing”, “clicking”, and “visiting”. Bigrams of consecutive activities include “viewing, clicking” and “clicking, visiting”. Bigrams of non-consecutive activities include “viewing, clicking”, “viewing, visiting” (non-consecutive activities), and “clicking, visiting”.

In an embodiment, the probability generator module 216 computes N-grams for each of the plurality of users, and thereafter, calculates the probabilities associated with each of the N-grams corresponding to each of the plurality of users. The probabilities are calculated for predefined time frames, such as, a single day, a week, a fortnight, or a month. Moreover, the predefined time frames are configurable. An administrator can change the time frames according to requirements. The probability of transition to an event B after an event A is calculated by the formula:

Prob(B|A)=#(B after A)/#A

where # stands for a numerical value of any event. In this embodiment, if A is an event and B is another event, then the total number of events where B occurs after A, is denoted by #(B after A). Also, the total number of events A only is denoted by #A. For example, if B is a visiting activity event and A is a searching event, then according to the above formula:

Prob(visit|search)=#(visit after search)/#search

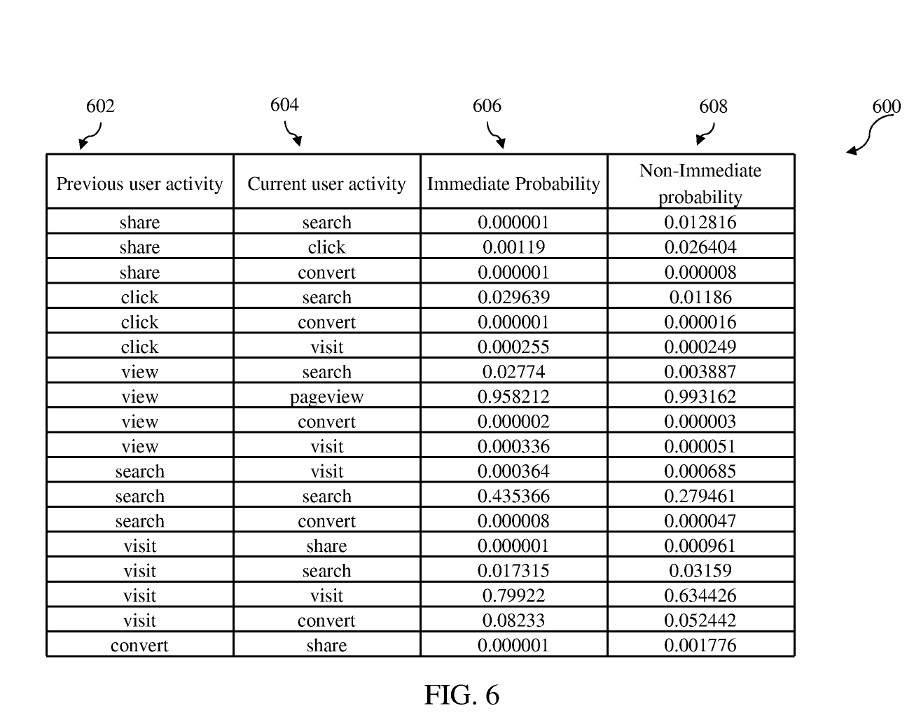

The probabilities determine how likely a transition is to occur from a current user activity to another user activity. The current user activity and another user activity correspond to a predefined group of user activities. The probabilities further provide an estimate of a time frame of occurrence of the transition of user activity for the plurality of users. The probability generator module 216 may represent the probability data 226 as, but not limited to, probabilities calculated using Gaussian distribution function, Poisson distribution function, Chi-square distribution function, etc. In another embodiment, the probability generator module 216 can increase the number N in the N-gram to include more historical activity context for computing the probability from past activities to the current activity of the user. An exemplary table 600 comprises the probability data. The exemplary table 600 is explained in detail below with reference to FIG. 6.

The analytics module 218 is configured to categorize the plurality of users based on the probabilities for a specific time frame and store the categorization in the analytics data 228. The plurality of users may be categorized based on content identifiers, user preferences, and/or the like.

The campaign module 220 is configured to deliver one or more versions of web contents from a plurality of versions of the web content to the plurality of users based on the plurality of categories stored in the analytics data 228. The plurality of versions of the web content is stored in the web content data 230. For example, assume two users A and B having interest in sports category but having different probabilities of transition. The users A and B will be served with different versions of the sports category. The different versions correspond to different probabilities of transitioning. The user A and the user B will be presented with different contents so as to reach a required conversion.

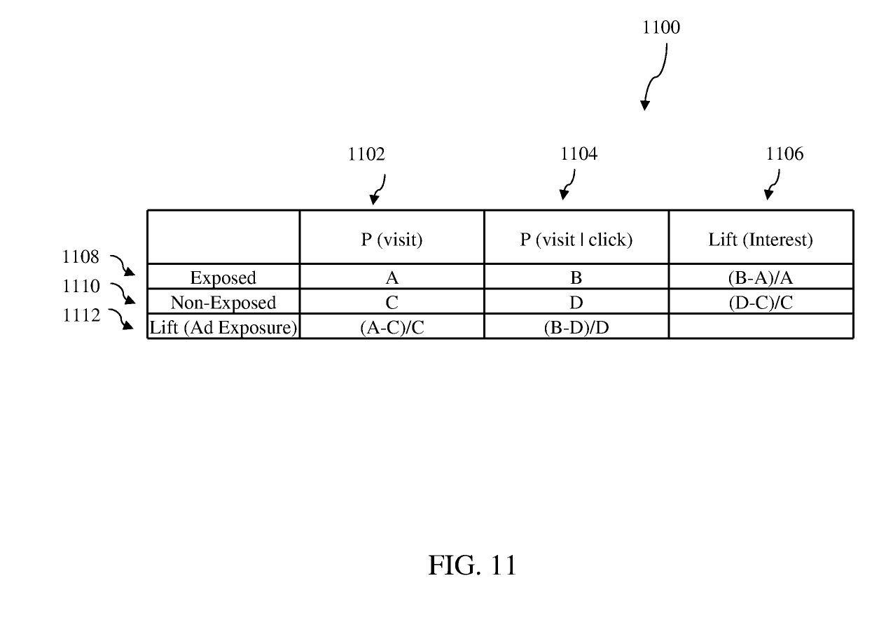

The reporting module 250 is configured to deliver reports related to the probabilities of user activities and the relative lifts between different user activities and different user groups. In an embodiment, the relative lifts would indicate the transition of the user to not necessarily the user's choice of path/ activity, but to an administrator influenced web activity. For example, the user A while browsing web content clicks on a pop-up ad or fills out a survey form loaded by the administrator. The reporting module 250 generates reports that are stored in reporting data 260. An illustration is presented in FIG. 11.

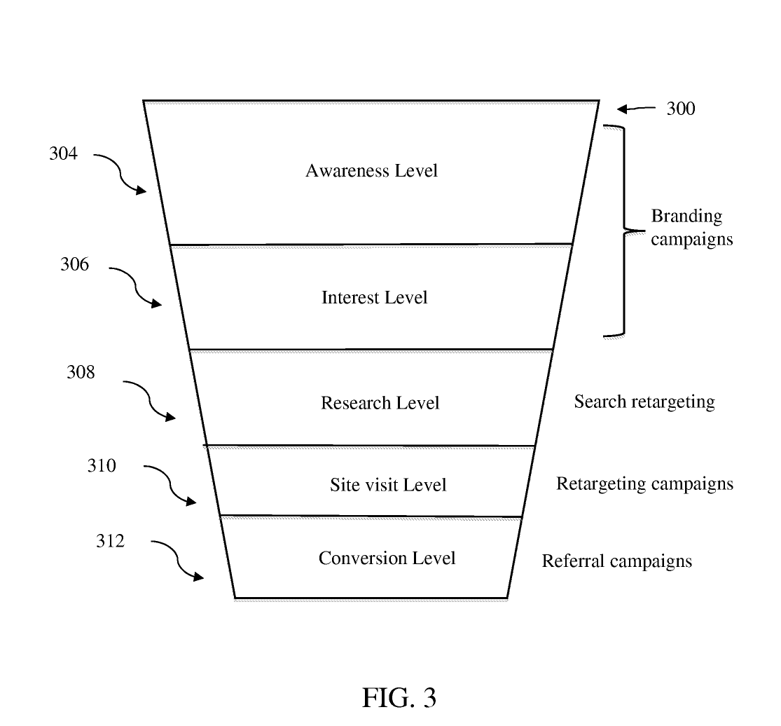

FIG. 3 illustrates a purchase funnel diagram 300 comprising a predefined group of user engagement levels in accordance with an embodiment. The purchase funnel diagram 300 is an application of the categorization framework. The purchase funnel diagram 300 and a sequence of the predefined user activities included herein provide a ground to determine user interests of the one or more users. The purchase funnel diagram 300 further identifies prospective purchasers who would appreciate the published web content. Each of the one or more users is characterized in terms of the predefined group of user activities. The purchase funnel diagram 300 relates to the user engagement levels which consist of an awareness level 304, an interest level 306, a research level 308, a site visit level 310, and a conversion level 312. Generally at the top of the purchase funnel diagram 300, the user is broadly aware of the brand or product and at the bottom of the purchase funnel diagram 300, the user is close to or at the point of making a purchase of a product.

In the upper part of the purchase funnel diagram 300, the user is generally engaged in viewing, sharing, clicking and searching of content broadly related to a brand, related categories or related topics. For example, the user who is planning a vacation will first consume content related to travel category through different activities, such as a visiting activity (viewing travel related sites), a searching activity (searching using various travel related keywords) and a sharing activity (sharing and clicking on content related to travel). These broadly correspond to the awareness level 304, the interest level 306, and the research level 308. In the lower part of the purchase funnel diagram 300, the user has narrowed the choice to a particular brand, searching and viewing pages related to this brand, and visiting this brand's web site. Therefore, these activities correspond to the site visit level 310, where the site visit level 310, generally, corresponds to an activity where the users visit one or more web links associated with the published web content. The site visit level 310 brings the one or more users closest to the conversion level 312. The conversion level 312 refers to a sales closure where the users make a purchase for the product or service corresponding to the published web content. In an embodiment, the conversion level 312 refers to winning a bid, utilizing a coupon, and/or the like.

In an embodiment, the campaign module 220 can be configured to target users based on the engagement levels they belong to, and different branding messages can be tailored to the users at different levels. Metrics for evaluating the impact of the campaigns at different stages can differ from level to level. At the upper part of the purchase funnel diagram 300 when the user is in the awareness level 304 or the interest level 306, the branding campaigns can be employed to put a message about the brand to the user. At the lower part of the purchase funnel diagram 300 when the user has shown high intent of converting, search retargeting or retargeting campaigns can enhance the brand message and bring the user back to the brand before they make a conversion.

FIG. 4 illustrates a table 400 showing various fields included within the at least one log record in accordance with an embodiment. The table 400 includes a column 402 labelled “Cookie ID” representing the plurality of users as cookies. A column 404 labelled as “URL” comprises one or more URLs associated with the user activities. A column 406 labelled as “refURL” comprises one or more URLs associated with the referring URLs (RefURLs) before the user lands on the URL. RefURLs are generally search engines such as www.google.com or www.bing.com, social networks such as www.facebook.com or www.twitter.com, and other affiliates sites. A column 408 labelled as “User activities” comprises one or more user activities from the predefined group of user activities. A column 410 labelled “Time Stamps” is a date/time field comprising date and time of occurrences of the user activities corresponding to each user. The at least one log record can be in a format, but not limited to, TXT, CSV, IIS, NCSA, W3C, ODBC, or one of various log formats or types in a heterogeneous computing environment . The log formats can be queried to access, parse, translate, reorder data fields or data elements, retrieve required data, and other operations that can be performed thereof.

FIG. 5 illustrates an activity data table 500 illustrating various fields generated by the user activity module 214 in accordance with an embodiment. The activity data table 500 is stored in the user activity data 224. The activity data table 500 includes a number of fields corresponding to the plurality of users, such as a column 502 labelled as “Cookie ID”, a column 504 labelled as “User Activity”, and a column 506 labelled as “Time Stamp”. The columns 502, 504, and 506 have already been explained in FIG. 4. A column 508 labelled as “URL” specifies the specific page or domain associated with the user activity. A column 510 labelled as “Category” specifies the content category associated with the URL in the column 508. A column 512 labelled as “Channel” specifies the social channel to which a share is posted or from which a click comes or a search channel from which a search click comes. For example, a user 198458 searched via the Google search engine and clicked on a web page “xyz.com/story1.htm” at time “30/09/2011 08:15”. Afterwards at time “30/09/2011 08:37”, the user 198458 visited the home page of “brand-x”, which is a consumer electronics brand. The user activity table 500 provides, for each user, a series of user activities annotated with details of the events, such as the web pages involved, the types of the events, the content categories or specific topics of the pages, the types of the content (e.g., news, video, blog, image, etc.), the commercial intent of the pages (e.g., informational, traversal, transactional), the channels involved, the types of the content etc. For one embodiment, the rich annotation of the user activities allows one to compute the probability data 226 in different ways, e.g., computing probabilities for all event types, or for only a specific set of activities of content categories or topics relevant to a brand, or for a specific set of social channels.

FIG. 6 illustrates a probability data table 600 generated by the probability generator module 216 in accordance with an embodiment. The probability data table 600 includes one or more fields such as, but not limited to, a column 602 labelled as “Previous User Activity”, a column 604 labelled as “Current User Activity”, a column 606 labelled as “Immediate Probability”, and a column 608 labelled as “Non-Immediate Probability”. In an embodiment, the probability generator module 216 retrieves the activities sequences from the user activity data 224, generates the activity N-grams for the plurality of users, and computes the associated probability of transition from a previous user activity to the current user activity for the one or more of the plurality of users. The transition probabilities between two specified user activities can be immediate, i.e., no other intermediate activities between the two specified activities, or can be non-immediate, i.e., there can be other intermediate activities between the two specified activities. The column 606 includes a probability of transition from the previous user activity as described in the column 602 to the current user activity as described in the column 604 without any other intermediate activities. The column 608 corresponds to a probability of transition from the previous user activity as described in the column 602 to the current user activity as described in the column 604 in a predefined time frame. The predefined time frame can be a day, a week, a fortnight, a month, or customizable time frames.

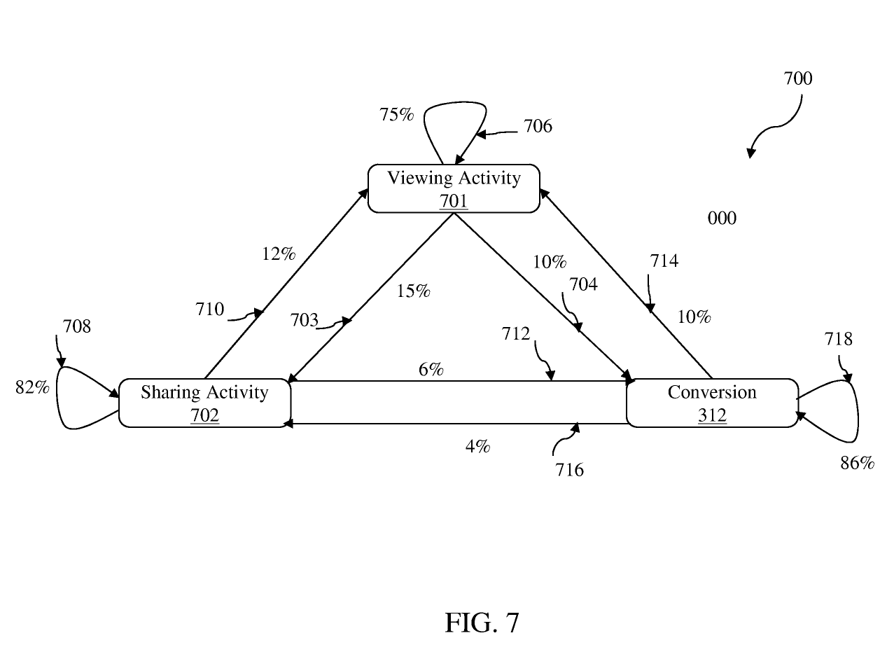

FIG. 7 illustrates a graph 700 depicting an immediate transition of the plurality of users occurring in a single day in accordance with an embodiment. The probabilities of transition for the plurality of users are provided by considering the transitions occurring in the viewing activity 701, the sharing activity 702 and the conversion 312 of preferably each of the plurality of users. In some embodiments, the immediate probabilities of transition are higher than non-immediate probabilities of transition for the same transition, potentially suggesting the time-sensitiveness between one type of activity and another type. For example, for a specific user, the probability of a transition 703 from the viewing activity 701 to the sharing activity 702 is 15%. Similarly, the probability of a transition 704 from the viewing activity 701 to the conversion 312 is 10%. Further, the probability of a transition 706 from the viewing activity 701 and continuing to remain in the same activity such as further viewing activity 701 is 75%. At a particular instant, the sum of probabilities of transition of a specific activity, for example, the viewing activity 701, aggregates to 100% (e.g. 15% (corresponding to a probability of the transition 703), 10% (corresponding to a probability of the transition 704), and 75% (corresponding to a probability of the transition 706)). The other probabilities of transition may be explained in the same way.

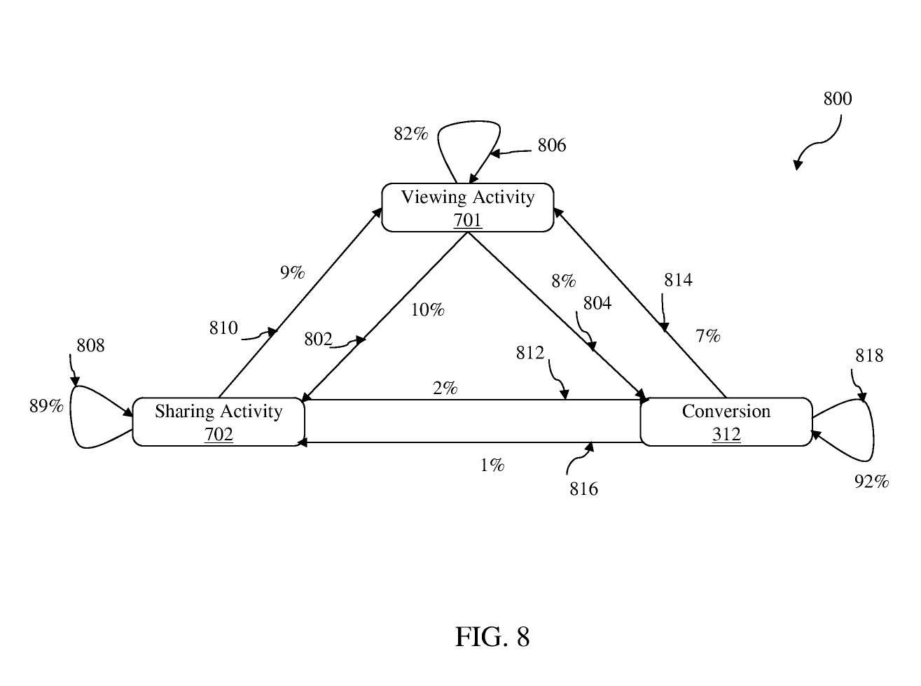

FIG. 8 illustrates a graph 800 depicting the non-immediate transition of the plurality of users occurring in a week in accordance with an embodiment. The probabilities of transition for the plurality of users are provided by considering the probabilities of conversion occurring from the viewing activity 701, the sharing activity 702 and the conversion 312 of preferably each of the plurality of users. For example, for a specific user, the probability of a transition 802 from the viewing activity 701 to the sharing activity 702 occurring in a week is 10%. Similarly, the probability of a transition 804 from the viewing activity 701 to the conversion 312 occurring in a week is 8%. Further, the probability of a transition 806 from the viewing activity 701 and continuing to remain in the same activity such as further viewing activity 701 occurring in a week is 82%. At a particular instant, the sum of probabilities of transition of a specific activity (e.g. the viewing activity 701) occurring in a week aggregates to 100% (e.g. 10% (corresponding to a probability of transition 802), 8% (corresponding to a probability of transition 804), and 82% (corresponding to a probability of the transition 806)). The other probabilities of transition may be explained in the same way.

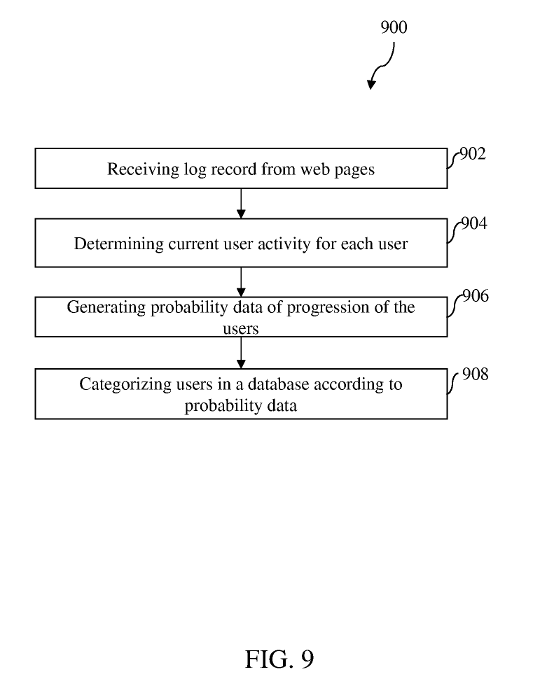

FIG. 9 is a flow chart 900 that illustrates a method of categorizing of users in accordance with an embodiment. FIG. 9 is explained in conjunction with FIG. 1 and FIG. 2.

At step 902, the tracking application module 212 receives the at least one log record from the tracking component 116. In an embodiment, the at least one log record corresponds to one or more user activities from a group of predefined user activities for preferably each of the plurality of users. The at least one log record is stored in the tracking log data 222.

At step 904, the user activity module 214 determines data associated with preferably each of the plurality of users based on the at least one log record from the tracking log data 222 and stores the data in the user activity data 224. Further, the user activity module 214 determines a current user activity for preferably each of the plurality of users based on the at least one log record. In an embodiment, the current user activity may correspond to the same user activity that is being performed by the plurality of users. The user activity module 214 further retrieves data corresponding to the one or more users, such as cookies, one or more user activities and corresponding time stamps, from the tracking log data 222. Thereafter, the user activity module 214 determines the current user activity by comparing time stamps for preferably each of the user activities corresponding to preferably each of the plurality of users. In an embodiment, the user activity module 214 further determines the previous user activity, and time spent in transition from a previous user activity to the current user activity by the plurality of users. Further, the user activity module 214 determines the time spent in the current user activity for the plurality of users. The user activity module 214 stores the current user activity and the previous user activity in the user activity data 224.

At step 906, the probability generator module 216 generates immediate and non-immediate probabilities for preferably each of the plurality of users and stores the probabilities in the probability data 226. The immediate and non-immediate probabilities for each of the plurality of users have already been explained in reference to FIG. 6. The probability generator module 216 generates the N-Grams for preferably each of the plurality of users. The N-grams may be based on stochastic models, but not limited to, Markov Model, Gillespie Algorithm, and/or the like. After calculating the N-grams, the probability generator module 216 calculates probability for each of the N-grams. In an embodiment, the probability generator module 216 generates probability data for one or more predefined time frames, the predefined time frames corresponding to a single day, a week, a fortnight, and a month customized by an administrator.

At step 908, the analytics module 218 categorizes the plurality of users based on the immediate and non-immediate probabilities from the probability data 226. In addition, the analytics module 218 categorizes the plurality of users based on the probability of transitioning from the previous user activity to the current user activity. In an embodiment, the plurality of users is categorized based on N-grams and the probabilities of each of the N-grams for each of the plurality of users. In an embodiment, the plurality of users may receive varying versions of web content based on the probabilities of transition. In another embodiment, the analytics module 218 categorizes the plurality of users based on a sharing category, a clicking category, a searching category, and/or a visiting category into the different engagement levels as shown in FIG. 3. The analytics module 218 stores the categorization of the plurality of users in the analytics data 228.

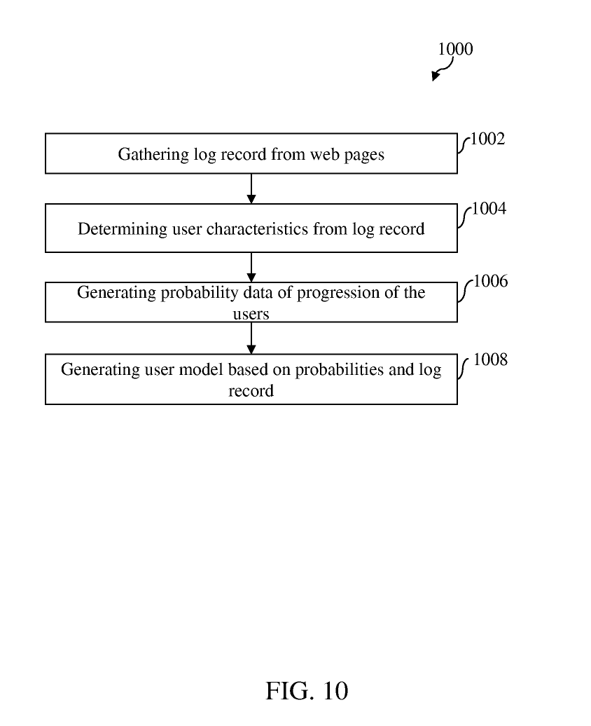

FIG. 10 is a flow chart 1000 that illustrates a computer implemented method for creating a user model in accordance with an embodiment. FIG. 10 is explained in conjunction with FIG. 1 and FIG. 2.

At step 1002, the tracking application module 212 gathers at least one log record from one or more web pages using the tracking component 116. The at least one log record is stored in the tracking log data 222.

At step 1004, the user activity module 214 determines user based data from the at least one log record. The user based data includes one or more user activities, content categories and user preferences associated with preferably each of the plurality of users. The user activity module 214 stored the user based data in the user activity data 224.

At step 1006, the probability generator module 216 determines the immediate and non-immediate probabilities associated with preferably each of the plurality of users and stores the probabilities in the probability data 226. The probability generator module 216 generates N-Grams for preferably each of the plurality of users. After calculating the N-grams, the probability generator module 216 calculates probabilities for each of the N-grams. In an embodiment, the probability generator module 216 generates probability data for one or more predefined time frames, the predefined time frames corresponding to a single day, a week, a fortnight, and a month.

At step 1008, the campaign module 220 generates a user model based at least in part on the probabilities from the probability data 226 and the at least one log record from the tracking log data 222. The user model is configured to map the plurality of users based on user characteristics and the determined probabilities. In an embodiment, the user model categorizes the plurality of users based on the user activities, content categories, user preferences, and/or the like. In another embodiment, the user model may re-target the plurality of users with a web content based on their categorization in the user model. In yet another embodiment, the user model may include a sample set that is created for specific time frames. Based on the sample set, a plurality of users can be targeted with the web content. The user model may include a separate sample set for ‘sports’, ‘news’, ‘shopping’, or any other content identifier. Further, the sample set for sports content identifier may categorize a plurality of users therein with probabilities of transition in certain time frames.

In another embodiment, the plurality of users can be targeted with different versions of particular web content based on the user model. For example, two users with the same content identifier but different user activities and different probabilities of transition are provided with differing versions of sports related web content. The differing versions of web content are selected from a plurality of versions of the web content. Each version of the same web content corresponds to a preferred version of web content associated with a plurality of categories of the categorization. The preferred version has a greater probability of leading a user to a point of conversion.

In yet another embodiment, the user model may be configured to record users who have been exposed to an advertiser campaign and who have not been exposed to an advertiser campaign. The probability data 226 can be generated for the different user groups to evaluate the impact of user characteristics, such as event types, content interests, etc, and to evaluate the impact of advertising campaigns.

FIG. 11 illustrates a table 1100 for computing the effect of previous user interest and the effect of an ad exposure based on the probability data 226. The table 1100 summarizes the impact of a user's social interests on the visiting activity of an advertiser's web page and the impact of the advertising campaign on the different user groups in accordance with an embodiment. In FIG. 11, two user groups are reported: an exposed group 1108 and a non-exposed group 1110. The exposed group 1108 includes the users who are exposed to the advertising messaging, and the non-exposed group 1110 includes the users who are not exposed to the advertising messaging. A column 1102 includes the computed probability of brand site visiting for the exposed group, e.g., probability A for the exposed group 1108 for visiting the brand's site. The column 1102 also includes the computed probability of brand site visiting for the unexposed group, e.g., probability C for the unexposed group 1110 for visiting the brand's site. A column 1104 includes the computed probability of the user visiting a web page hosted by the brand after a combined N-grams activity (visiting +clicking) for the exposed group, e.g., probability B for the exposed group 1108 for visiting the brand's site after a clicking activity. The column 1104 also includes the computed probability of the user visiting the web page hosted by the brand after a combined N-grams activity (visiting +clicking) for the unexposed group, e.g., probability D for the unexposed group 1110 for visiting the brand's site after a clicking activity. In one embodiment, the difference between the two probablities A and B with respect to the unigram probability A is the interest-related lift, which shows whether, after a clicking event, the probablity of visiting the sites increased or decreased. A positive number means the previous activity positively impacts the occurrence of the next activity. In another embodiment, for the column 1102, the exposed group 1108 can be compared with the non-exposed group 1110 for the same type of probability P (visit). The difference between the probabilities A and C with respect to the probability C is an Ad exposure lift 1112, which reflects the impact of the advertising messaging on the probability of visiting. Similarly, the ad exposure lift 1112 can be computed for the column 1104 for the transitional probability from a clicking activity to a visiting activity.

The disclosed methods and systems, as described in the ongoing description or any of its components, may be embodied in the form of a computer system. Typical examples of a computer system include, but are not limited to, a general-purpose computer, a programmed microprocessor, a micro-controller, a peripheral integrated circuit element, and other devices or arrangements of devices that are capable of implementing the steps that constitute the method of the present disclosure.

The computer system comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system may also include a communication unit. The communication unit allows the computer to connect to other databases and the Internet through an Input/output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through an input device, accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The programmable or computer readable instructions may include various commands that instruct the processing machine to perform specific tasks such as the steps that constitute the method of the present disclosure. The method and systems described can also be implemented using only software programming or using only hardware or by a varying combination of the two techniques. The present disclosure is independent of the programming language used and the operating system in the computers. The instructions for the present disclosure can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the present disclosure. The software may also include modular programming in the form of object-oriented programming. The processing of input data by the processing machine may be in response to user commands, results of previous processing or a request made by another processing machine. The present disclosure can also be implemented in all operating systems and platforms including, but not limited to, ‘Unix’, ‘DOS’, ‘Android’, ‘Symbian’, and ‘Linux’.

The programmable instructions can be stored and transmitted on a non-transitory computer readable medium. The programmable instructions can also be transmitted by data signals across a carrier wave. The present disclosure can also be embodied in a computer program product comprising a non-transitory computer readable medium, the product capable of implementing the above methods and systems, or the numerous possible variations thereof.

While various embodiments have been illustrated and described, it will be clear that the present disclosure is not limited to these embodiments only. Numerous modifications, changes, variations, substitutions and equivalents will be apparent to those skilled in the art without departing from the spirit and scope of the present disclosure as described in the claims.

what is claimed is:

1. A computer-implemented method for categorizing a plurality of users browsing one or more web pages, the method comprising:
receiving at least one log record corresponding to one or more user activities from a predefined group of user activities for the plurality of users;
determining a current user activity from the predefined group of user activities for the plurality of users based on the corresponding at least one log record;
generating a probability data that defines a transition from the current user activity to another user activity in the predefined group of user activities for the plurality of users; and
categorizing the plurality of users based on the probability data.

2. The method of claim 1, wherein the at least one log record comprises one or more of cookies representing the plurality of users, timestamps, user activities, sharing channels, and content categories.

3. The method of claim 1, wherein the predefined group of user activities comprises one or more of a viewing activity, a clicking activity, a sharing activity, a searching activity, a visiting activity, an ad exposure activity, an ad clicking activity, and a conversion activity.

4. The method of claim 1 further comprising determining time spent in a transition from a previous user activity to the current user activity.

5. The method of claim 1, wherein the probability data comprises a probability of the transition for a predefined time frame, the predefined time frame corresponding to one or more of a day, a week, a fortnight, and a month.

6. The method of claim 1, wherein the probability data comprises a probability of remaining in the current user activity for a predefined time frame for the plurality of users.

7. The method of claim 1, wherein the probability data comprises:
N-grams for ascertaining transition of the plurality of users from the current user activity to another user activity from the predefined group of user activities; and
one or more probabilities corresponding to the N-grams for the plurality of users.

8. A web analytics server to categorize a plurality of users browsing one or more web pages, the web analytics server comprising:
a tracking application module configured to receive at least one log record, the at least one log record corresponding to one or more user activities from a predefined group of user activities for the plurality of users;
a probability generator module configured to generate a probability data that defines a transition from a current user activity to another user activity in the predefined group of user activities for the plurality of users; and
an analytics module configured to categorize the plurality of users into a plurality of categories based on the probability data.

9. The web analytics server of claim 8 further comprising a tracking component configured to generate at least one log record, the tracking component corresponding to one or more of a widget, a button, a web bug, a web beacon, a hypertext, a tracking pixel, a link on each web page, a local shared object (LSO), and a HyperText Markup Language (HTML) tracking code.

10. The web analytics server of claim 8, wherein the at least one log record comprises at least one of an anonymous cookie, a click log, a sharing log, a timestamp, an event type, a sharing channel, a content identifier, a URL, a domain information and a browser agent information.

11. The web analytics server of claim 8 further comprising a user activity module configured to determine the current user activity for the plurality of users.

12. The web analytics server of claim 8, wherein the predefined group of user activities comprises at least one of a viewing activity, a clicking activity, a sharing activity, a searching activity, a visiting activity, an ad exposure activity, an ad clicking activity, and a conversion activity.

13. The web analytics server of claim 8, wherein the plurality of categories corresponds to various engagement levels in a purchase funnel.

14. The web analytics server of claim 8 further comprising a campaign module configured to deliver one or more web content to the plurality of users based on the plurality of the categories.

15. A computer implemented method for creating a user model comprising a plurality of users browsing one or more web pages, the method comprising:
gathering at least one log record from the one or more web pages;
determining one or more user characteristics based at least in part on the at least one record;
determining probability data that defines a transition of the plurality of users from a current user activity to any other user activity in a predefined group of user activities; and
generating the user model based at least in part on the determined probability and the at least one log record.

16. The computer implemented method of claim 15, wherein the user model is configured to map the plurality of users based on user characteristics and the determined probability data.

17. The computer implemented method of claim 15, wherein the user characteristics corresponds to one or more of the plurality of user activities, content categories, and user preferences.

18. The computer implemented method of claim 15 further comprising delivering a version of the web content from a plurality of versions of the web content to the plurality of users based at least in part on the probability data.

19. The computer implemented method of claim 15, wherein the version of the web content corresponds to a preferred version of web content associated with one of a plurality of categories of the plurality of users.

20. A computer program product for use with a computer, the computer program product embodied on a non-transitory computer readable medium, the computer program product comprising:
programmed instructions to receive at least one log record, the at least one log record corresponding to one or more user activities from a predefined group of user activities for a plurality of users, wherein the predefined group of user activities are retrieved from a data set in a database;
programmed instructions to generate a probability data that defines a transition from a current user activity to another user activity of a web content in the predefined group of user activities for the plurality of users; and
programmed instructions to categorize the plurality of users into a plurality of categories based on the probability data.
